(19) United States
(12) Patent Application Publication
(10) Pub. No.: US 2023/0375686 A1
(43) Pub. Date: Nov. 23, 2023

(54) TAG POSITIONING METHOD AND RELATED DEVICE

(71) Applicant: HUAWEI TECHNOLOGIES CO., LTD., Shenzhen (CN)

(72) Inventors: Xibao FENG, Beijing (CN); Yiling WU, Beijing (CN); Zhenwei LU, Shenzhen (CN); Chenwan LI, Beijing (CN)

(21) Appl. No.: 18/358,441

(22) Filed: Jul. 25, 2023

Related U.S. Application Data
(63) Continuation of application No. PCT/CN2022/073684, filed on Jan. 25, 2022.

(30) Foreign Application Priority Data
Jan. 31, 2021 (CN) 202110132083.X

(51) Int. Cl. G01S 13/06; G01S 5/02; G06K 7/10

(52) U.S. Cl. CPC G01S 13/06; G01S 5/02; G06K 7/10009

(57) ABSTRACT

This application discloses a tag positioning method. In this application, a target tag receives first signaling sent by a target reader/writer, where the first signaling includes an identity ID of a first transmitter. The target tag sends second signaling to the target reader/writer, where the second signaling includes the ID of the first transmitter. Further, the target reader/writer may determine, based on the ID that is of the first transmitter and that is included in the signaling sent by the target tag, a coverage area that is of a transmitter and in which the target tag is located, to more accurately determine a location of the tag. Therefore, efficiency of tag positioning is improved.

### CROSS-REFERENCE TO RELATED APPLICATIONS

This application is a continuation of International Application No. PCT/CN2022/073684, filed on Jan. 25, 2022, which claims priority to Chinese Patent Application No. 202110132083.X, filed on Jan. 31, 2021. The disclosures of the aforementioned applications are hereby incorporated by reference in their entireties.

### BACKGROUND

The radio frequency identification (radio frequency identification, RFID) technology is a contactless automatic identification technology. A reader/writer (interrogator) charges a tag by sending an excitation signal to the tag (tag). The tag receives signaling sent by the target reader/writer, and the tag sends the signaling to the target reader/writer through a reflected signal. In this way, the target reader/writer identifies an ID of the tag, and perform operations such as reading and writing on the tag.

The tag is widely used in positioning scenarios. After the tag receives an identity included in information sent by the reader/writer, the tag sends the identity to a positioning device such as a server through a communication network. The positioning device incorporates the tag into a range covered by the reader/writer based on a pre-stored location of the reader/writer.

In a conventional communication process, a reader/writer sends RFID signaling to a tag to locate the tag. Protocol signaling sent between the reader/writer and the tag includes less information content, and efficiency of tag positioning is low.

### SUMMARY

Embodiments described herein provide a tag positioning method. In this method, a target reader/writer determines, based on an identity (identity, ID) that is of a first transmitter and that is included in signaling sent by a target tag, a coverage area that is of a transmitter and in which the target tag is located, to more accurately determine a location of the tag. Therefore, efficiency of tag positioning is improved.

A first aspect of at least one embodiment provides a tag positioning method. In this method, a target tag receives first signaling sent by a target reader/writer, where the target reader/writer includes a first transmitter and a first receiver, and the first signaling includes an identity of the first transmitter; and the target tag sends second signaling to the target reader/writer, where the second signaling includes the identity of the first transmitter.

In at least one embodiment, the target tag receives the first signaling sent by the target reader/writer, where the first signaling includes the identity ID of the first transmitter. The target tag sends the second signaling to the target reader/writer, where the second signaling includes the ID of the first transmitter. Further, the target reader/writer determines, based on the ID that is of the first transmitter and that is included in the signaling sent by the target tag, a coverage area that is of a transmitter and in which the target tag is located, to more accurately determine a location of the tag. Therefore, efficiency of tag positioning is improved.

In at least one embodiment of the first aspect, the first signaling includes inventory signaling, and the inventory signaling includes selection signaling (Select), query signaling (Query), acknowledgment signaling (acknowledge, ACK), negative acknowledgment signaling (negative acknowledge, NAK) and/or query signaling (Queryrep).

In at least one embodiment, the target reader/writer uses a transmit/receive separation architecture. After being separated, the target reader/writer includes at least the first transmitter and the first receiver. Optionally, the target reader/writer further includes more transmitters such as a second transmitter. This is not specifically limited herein. The target reader/writer sends the first signaling to the target tag. Optionally, the first signaling is the inventory signaling, and the inventory signaling refers to signaling in an inventory process. Specifically, the inventory signaling is the selection signaling Select, the query signaling Query, the acknowledgment signaling ACK, the negative acknowledgment signaling NAK, and/or the query signaling Queryrep. This is not specifically limited herein. A plurality of types of inventory signaling include the identity of the first transmitter, the target tag sends the identity of the first transmitter to the target reader/writer, and the identity of the first transmitter is used to locate the target tag. This improves accuracy of locating the tag by the target reader/writer.

In at least one embodiment of the first aspect, the second signaling includes the inventory signaling, and the inventory signaling includes reply signaling Reply and/or electronic product code (electronic product code, EPC).

In at least one embodiment, the target tag sends the identity of the first transmitter to the target reader/writer through the reply signaling Reply and/or the electronic product code. After receiving the identity of the first transmitter, the target reader/writer locates the target tag by using the identity. This improves accuracy of tag positioning by the target reader/writer.

In at least one embodiment of the first aspect, the method further includes: The target tag receives third signaling sent by the target reader/writer, where the third signaling indicates the target tag to send the second signaling to the target reader/writer.

In at least one embodiment, the tag does not carry an identity of a transmitter in the inventory signaling. After the inventory process ends, the target reader/writer sends an instruction to the target tag through the third signaling, where the third signaling is dedicated signaling that indicates the target tag to send the identity of the first transmitter to the target reader/writer. For example, in response to a transmitter ID enable bit carried by the reader/writer in the inventory signaling being disabled, the inventory signaling sent by the tag to the reader/writer does not include the identity of the transmitter. Therefore, the reader/writer enables, through the dedicated signaling after inventory, the tag to send, to the reader/writer, an identity of a transmitter of the reader/writer. This implementation provides an implementation in which the target tag sends the identity of the first transmitter to the target reader/writer, and improves flexibility of the solution.

In at least one embodiment of the first aspect, the target reader/writer includes a second transmitter, and the method further includes: The target tag determines that a reporting condition is met; and the target tag sends fourth signaling to the target reader/writer, where the fourth signaling includes an identity of the second transmitter.

In response to the target tag determines that the reporting condition being met, the target tag sends the fourth signaling to the target reader/writer.

In at least one embodiment, optionally, the reporting condition of the tag is sent by the reader/writer, or the reporting condition of the tag is obtained in another manner. This is not specifically limited herein. Optionally, the reporting condition is that the tag switches a transmitter, the reporting condition is that preset reporting time of the tag is reached, or the reporting condition is another condition. This is not specifically limited herein.

(1) The Tag Switches a Transmitter.

In this embodiment, the target reader/writer includes the first transmitter and the second transmitter, and the first transmitter and the second transmitter are not a same network device. The target tag communicates with the target reader/writer through the first transmitter. After the target tag moves, and the target tag goes beyond a coverage area of the first transmitter and enters a coverage area of the second transmitter, the target tag switches a transmitter and communicates with the target reader/writer through the second transmitter. Alternatively, coverage areas of the first transmitter and the second transmitter overlap, and the target tag switches from the first transmitter to the second transmitter. In this case, an identity that is of a transmitter and that is included in signaling sent by the target reader/writer and that is received by the target tag again is the identity of the second transmitter, and the target tag confirms that the received identity of the transmitter is switched from the identity of the first transmitter to the identity of the second transmitter. That is, the received identity of the transmitter changes. In this case, the target tag determines that the reporting condition is met, and the target tag sends the identity of the second transmitter to the target reader/writer through the fourth signaling. Optionally, the fourth signaling is signaling included in the inventory signaling (such as Select, Query, Reply, ACK, NAK, EPC, Queryrep, and/or Queryadjust). Signaling included in the fourth signaling is also signaling other than the inventory signaling. This is not specifically limited herein.

(2) The Preset Reporting Time of the Tag Reaches.

In at least one embodiment, the first transmitter and the second transmitter are a same network device. After determining that the preset reporting time reaches, the target tag reports the identity of the second transmitter (the identity of the first transmitter) to a receiver of the reader/writer through the fourth signaling. Optionally, the preset reporting time is obtained by skilled persons by configuring for the target tag through the target tag, and the preset reporting time is sent by a receiver to the target tag through the inventory signaling or other signaling. The preset reporting time is also obtained in another manner. The reader/writer specifies, through the first signaling, the target tag to report the identity of the first transmitter in specific signaling. This is not specifically limited herein.

In at least one embodiment, optionally, the first signaling further includes reporting time of the identity of the first transmitter.

Optionally, the target reader/writer sends the reporting time of the identity of the first transmitter to the target tag through the first signaling. The reporting time specifies that the target tag sends the identity of the first transmitter to the target reader/writer at a specific moment, and the reporting time specifies that the target tag sends the identity of the first transmitter to the target reader/writer after a time period. For example, inventory signaling Select includes the reporting time, and the reporting time indicate the tag to carry an identity of a transmitter at a moment of sending EPC. The reader/writer sends Select that carries the reporting time to the tag, and after the tag receives Select, the tag carries the identity of the transmitter in response to sending the EPC. The reporting time is alternatively the target tag sends the identity of the first transmitter to the target reader/writer after receiving the third signaling mentioned in the foregoing embodiment. This is not specifically limited herein.

In at least one embodiment, the target reader/writer configures, in a plurality of manners, the target tag to report the identity at different time. This improves flexibility of the solution.

In at least one embodiment of the first aspect, the first signaling includes a quantity of reporting times of the identity of the first transmitter.

(1) Report for One Time or Report in all Signaling

For example, the quantity that is of reporting times and that is included in the first signaling indicates that the identity of the first transmitter is reported for one time. The reader/writer specifies, through the first signaling, the target tag to report the identity of the first transmitter in specific signaling. After the identity of the first transmitter is reported to the target reader/writer in the specific signaling, the identity of the first transmitter is no longer reported to the target reader/writer in other signaling than the specific signaling. The quantity that is of reporting times and that is included in the first signaling indicates to report the identity of the first transmitter in all signaling. The reader/writer specifies, through the first signaling, the target tag to report the identity of the first transmitter in all signaling that is sent to the reader/writer. The signaling mentioned in this embodiment is signaling included in the inventory signaling, or is signaling other than the inventory signaling. This is not specifically limited herein. In at least one embodiment, signaling that is received by the target tag earlier than the first signaling carries an identity of a transmitter used last time, or carries an invalid identity. This is not specifically limited herein.

(2) Random Reporting

For example, in this application, the quantity that is of reporting times and that is included in the first signaling indicates random reporting, the identity that is of the first transmitter and that is sent by the target tag to the reader/writer is included in any piece of signaling, and the target reader/writer identifies, in a plurality of manners, the signaling that carries the identity of the first transmitter. In this manner, the target reader/writer configures, in a plurality of manners, the target tag to report the identity in different manners. This improves implementability of the solution.

In at least one embodiment of the first aspect, the identity of the first transmitter is transmitted in plaintext, or the identity of the first transmitter is transmitted in encrypted transmission.

In at least one embodiment, optionally, the identity of the first transmitter is sent to the target reader/writer in a plaintext transmission manner. Optionally, the identity of the first transmitter is transmitted to the target reader/writer in an encrypted transmission manner. For example, the target tag encrypts the identity of the first transmitter and an RN 16 in an exclusive OR manner, and then send the encrypted identity to the target reader/writer. Alternatively, the target tag encrypts the identity of the first transmitter in another manner, and send the encrypted identity to the target reader/writer. This is not specifically limited. In at least one embodiment, two specific sending forms are provided, and implementability of the solution is improved.

A second aspect of at least one embodiment provides a tag positioning method. In this method, a target reader/writer sends first signaling to a target tag, where the target reader/writer includes a first transmitter and a first receiver, and the first signaling includes an identity of the first transmitter; the target reader/writer receives second signaling sent by the target tag, where the second signaling includes the identity of the first transmitter; and the target reader/writer predicts a location of the target tag based on the identity of the first transmitter.

In at least one embodiment, the target reader/writer sends the first signaling to the target tag, where the first signaling includes the identity ID of the first transmitter. The target reader/writer receives the second signaling sent by the target tag, where the second signaling includes the ID of the first transmitter. Further, the target reader/writer determines, based on the ID that is of the first transmitter and that is included in the signaling sent by the target tag, a coverage area that is of a transmitter and in which the target tag is located, to more accurately determine a location of the tag. Therefore, efficiency of tag positioning is improved.

In at least one embodiment of the second aspect, the first signaling includes inventory signaling, and the inventory signaling includes selection signaling Select, query signaling Query, acknowledgment signaling ACK, negative acknowledgment signaling NAK, and/or query signaling Queryrep.

In at least one embodiment, the target reader/writer uses a transmit/receive separation architecture. After being separated, the target reader/writer includes at least the first transmitter and the first receiver. Optionally, the target reader/writer further includes more transmitters such as a second transmitter. This is not specifically limited herein. The target reader/writer sends the first signaling to the target tag. Optionally, the first signaling is the inventory signaling, and the inventory signaling refers to signaling in an inventory process. Specifically, the inventory signaling is the selection signaling Select, the query signaling Query, the acknowledgment signaling ACK, the negative acknowledgment signaling NAK, and/or the query signaling Queryrep. This is not specifically limited herein. A plurality of types of inventory signaling include the identity of the first transmitter, the target tag sends the identity of the first transmitter to the target reader/writer, and the identity of the first transmitter is used to locate the target tag. This improves accuracy of locating the tag by the target reader/writer.

In at least one embodiment of the second aspect, the second signaling includes the inventory signaling, and the inventory signaling includes reply signaling Reply and/or electronic product code EPC.

In at least one embodiment, the target tag sends the identity of the first transmitter to the target reader/writer through the reply signaling Reply and/or the electronic product code EPC. After receiving the identity of the first transmitter, the target reader/writer locates the target tag by using the identity. This improves accuracy of tag positioning by the target reader/writer.

In at least one embodiment of the second aspect, the method further includes: The target reader/writer sends third signaling to the target tag, where the third signaling indicates the target tag to send the second signaling to the target reader/writer.

In at least one embodiment, the tag does not carry an identity of a transmitter in the inventory signaling. After the inventory process ends, the target reader/writer sends an instruction to the target tag through the third signaling, where the third signaling is dedicated signaling that indicates the target tag to send the identity of the first transmitter to the target reader/writer. For example, in response to a transmitter ID enable bit carried by the reader/writer in the inventory signaling being disabled, the inventory signaling sent by the tag to the reader/writer does not include the identity of the transmitter. Therefore, the reader/writer enables, through the dedicated signaling after inventory, the tag to send, to the reader/writer, an identity of a transmitter of the reader/writer. This implementation provides an implementation in which the target tag sends the identity of the first transmitter to the target reader/writer, and improves flexibility of the solution.

In at least one embodiment of the second aspect, the target reader/writer includes a third transmitter, and the method further includes: The target reader/writer obtains first configuration information through the first receiver, where the first configuration information indicates a location of the third transmitter and/or a deployment relationship between a plurality of third transmitters.

In at least one embodiment, the first configuration information indicates the location of the third transmitter and/or the deployment relationship between the plurality of third transmitters. The third transmitter refers to a transmitter in a subset of all transmitters that communicate with the first receiver. Optionally, the first receiver obtains the first configuration information through a network device such as a database or a server that stores a topological relationship. Alternatively, the first receiver receives the first configuration information sent by one or more third transmitters. Alternatively, the first receiver obtains the first configuration information in another manner. This is not specifically limited herein. In at least one embodiment, the target reader/writer learns of a location of each transmitter based on the first configuration information, and further determine a location of the tag based on the location of the transmitter and the identity of the transmitter. This improves implementability of the solution.

In at least one embodiment of the second aspect, the method further includes: The target reader/writer sends second configuration information to the transmitter through the receiver, where the second configuration information indicates a configuration used for communication between the target tag and the target reader/writer.

In at least one embodiment, the second configuration information indicates the configuration used for communication between the target tag and the target reader/writer. The tag communicates with the reader/writer through a transmitter A. In response to the tag moving, after the reader/writer predicts a moving track of the tag, the reader/writer infers that the tag communicates with the reader/writer through a transmitter B at a next moment. The reader/writer sends the second configuration information to the transmitter B. For example, the reader/writer adds a mask (the second configuration information) to the selection signaling Select sent to the transmitter B, to accelerate an inventory speed of the tag by the reader/writer and improve inventory efficiency.

According to the foregoing technical solutions, embodiments described herein have the following advantages.

In at least one embodiment, the target tag receives the first signaling sent by the target reader/writer, where the first signaling includes the identity ID of the first transmitter. The target tag sends the second signaling to the target reader/writer, where the second signaling includes the ID of the first transmitter. Further, the target reader/writer determines, based on the ID that is of the first transmitter and that is included in the signaling sent by the target tag, a coverage area that is of a transmitter and in which the target tag is located, to more accurately determine a location of the tag. Therefore, efficiency of tag positioning is improved.

### BRIEF DESCRIPTION OF DRAWINGS

FIG. 1 is a schematic diagram of an embodiment of a tag and a reader/writer according to at least one embodiment;

FIG. 2 is a schematic diagram of an embodiment of an inventory process according to at least one embodiment;

FIG. 3 is a schematic diagram of another embodiment of an inventory process of a tag according to at least one embodiment;

FIG. 4 is a schematic diagram of an embodiment of a tag positioning system according to at least one embodiment;

FIG. 5 is a schematic diagram of an embodiment of a tag positioning method according to at least one embodiment;

FIG. 6 is a schematic diagram of another embodiment of a tag positioning method according to at least one embodiment;

FIG. 7 is a schematic diagram of another embodiment of a tag positioning method according to at least one embodiment;

FIG. 8 is a schematic diagram of another embodiment of a tag positioning method according to at least one embodiment;

FIG. 9 is a schematic diagram of another embodiment of a tag positioning method according to at least one embodiment;

FIG. 10 is a schematic diagram of another embodiment of a tag positioning method according to at least one embodiment;

FIG. 11a is a schematic diagram of another embodiment of a tag positioning method according to at least one embodiment;

FIG. 11b is a schematic diagram of another embodiment of a tag positioning method according to at least one embodiment;

FIG. 12 is a schematic diagram of a structure of a tag device according to at least one embodiment;

FIG. 13 is a schematic diagram of a structure of a reader/writer according to at least one embodiment; and

FIG. 14 is a schematic diagram of a structure of a network device according to at least one embodiment.

### DESCRIPTION OF EMBODIMENTS

The following describes examples provided in at least one embodiment with reference to the accompanying drawings. The described examples are merely some rather than all examples described herein. Persons of ordinary skill in the art know that, with development of technologies and emergence of a new scenario, the technical solutions provided in at least one embodiment are also applicable to similar technical problems.

In at least one embodiment, claims, and accompanying drawings, the terms “first”, “second”, and the like are intended to distinguish between similar objects but do not necessarily indicate a specific order or sequence. The termed in such a way is interchangeable in proper circumstances so that examples described herein is implemented in other orders than the order illustrated or described herein. In addition, the terms “include” and “have” and any other variants are intended to cover the non-exclusive inclusion. For example, a process, method, system, product, or device that includes a list of steps or units is not necessarily limited to those expressly listed steps or units, but includes other steps or units not expressly listed or inherent to such a process, method, product, or device.

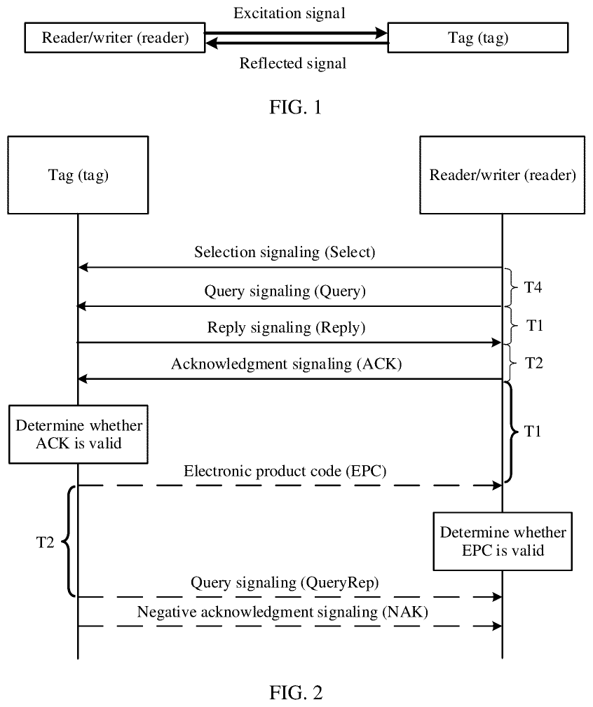

FIG. 1 is a schematic diagram of an embodiment of a tag and a reader/writer according to at least one embodiment.

Refer to FIG. 1. As shown in FIG. 1, an RFID technology is a contactless automatic identification technology. The reader/writer charges the tag by sending an excitation signal to the low-cost tag, the tag receives signaling sent by the reader/writer, and the tag sends the signaling to the reader/writer through a reflected signal. In this way, the reader/writer identifies an ID of the tag, and the reader/writer performs a read/write operation on the tag. The reader/writer further performs other operations on the tag. This is not specifically limited herein.

The tag is widely used in positioning scenarios. After the tag receives an identity included in information sent by the reader/writer, the tag sends the identity to a positioning device such as a server through a communication network. The positioning device incorporates the tag into a range covered by the reader/writer based on a pre-stored location of the reader/writer.

In a conventional communication process, a reader/writer sends RFID signaling to a tag to locate the tag. In a case in which one receiver is corresponding to a plurality of transmitters, the receiver cannot determine a coverage area of which transmitter and in which the tag is located, and the receiver obtains positioning information of the tag through signal quality. As a result, positioning precision is not sufficiently precise, and positioning efficiency is low.

To resolve a problem in the foregoing solution, at least one embodiment provides a tag positioning method. In at least one embodiment, a target tag receives first signaling sent by a target reader/writer, where the first signaling includes an identity of a first transmitter. The target tag sends second signaling to the target reader/writer, where the second signaling includes the identity of the first transmitter. Further, the target reader/writer determines, based on the identity that is of the first transmitter and that is included in the second signaling sent by the target tag, a coverage area that is of a transmitter and in which the target tag is located, to more accurately determine a location of the tag. Therefore, efficiency of tag positioning is improved.

FIG. 2 is a schematic diagram of an embodiment of an inventory process according to at least one embodiment.

Refer to FIG. 2. The following briefly describes an inventory process of a tag in FIG. 2.

A reader/writer sends selection signaling (Select) to the tag, where Select is used to select a subset of the tag, and the subset of the tag includes a plurality of tags. In addition, Select is used to modify an inventory flag bit of a session (session).

The reader/writer sends query signaling (Query) to the tag, where Query is used to select a session from a plurality of sessions and select a tag that matches an inventory flag bit in the session. Further, an inventory process of a tag that is in the subset and that is selected by Select is initialized, and each tag that is in the subset and that is selected by the selection signaling Select selects a random number to initialize a counter (counter).

The tag sends reply signaling (Reply) to the reader/writer, and an RN 16 included in Reply indicates a temporary identity of the tag. After the tag receives query signaling, in response to the tag confirms that counter=0, the tag selects a 16-bit random number as the RN 16, and the RN 16 is fed back to the reader/writer. In response to the reader/writer detects that the tag feeds back the RN 16, the inventory process is normal, and the reader/writer performs a subsequent step.

The reader/writer sends acknowledgment signaling ACK to the tag, where ACK indicates that the reader/writer successfully receives the RN 16 sent by the tag, and ACK includes the 16-bit random number that is fed back by the tag and that is used by the tag to check whether ACK is correct.

In response to the tag confirms that the 16-bit random number included in ACK being the same as the RN 16 sent by the tag, the tag sends electronic product code to the reader/writer, where the EPC indicates an actual ID of the tag.

In response to the reader/writer confirms that the EPC sent by the tag being valid, the reader/writer sends query signaling (QueryRep or QueryAdjust) to the tag. In response to the reader/writer receiving counter-1 of all tags that receive the query signaling, or the reader/writer reslecting a random number to initialize the counter based on QueryAdjust, the inventory process ends.

In response to the reader/writer confirms that the EPC sent by the tag being invalid, the reader/writer sends negative acknowledgment (negative acknowledge, NAK) signaling to the tag.

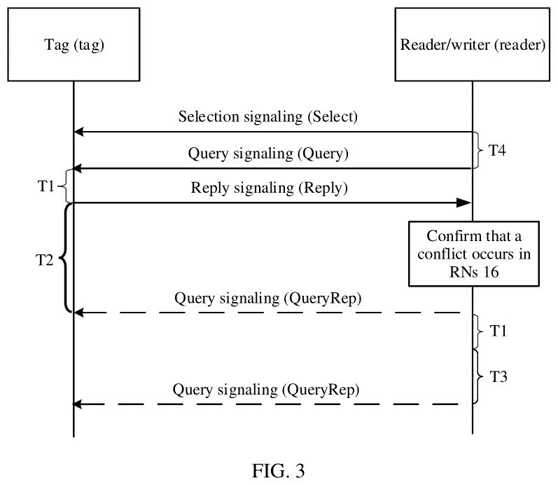

FIG. 3 is a schematic diagram of another embodiment of an inventory process of a tag according to at least one embodiment.

Refer to FIG. 3. The following briefly describes the inventory process in FIG. 3.

In at least one embodiment, functions of sending, by a reader/writer, Select and Query to the tag, and sending, by the tag, Reply to the reader/writer are similar to functions in the embodiment shown in FIG. 2. Details are not described herein again.

In response to a plurality of tags all sending an RN 16 to the reader/writer, in response to the reader/writer determining that a conflict occurs between RNs 16 sent by the plurality of tags, the reader/writer does not send ACK to the tag, but directly sends QueryRep, skips these conflicting tags, and directly performs a subsequent inventory process. In addition, in response to the reader/writer not detecting that the tag feeds back an RN 16, the reader/writer also directly performs a subsequent inventory process (for example, sending QueryRep).

The following briefly describes time intervals in embodiments shown in FIG. 2 and FIG. 3.

In at least one embodiment, T1 is a time interval between time at which the reader/writer completes sending of signaling and time at which the tag starts to send signaling, and the tag should meet a time sequence requirement during processing. T4 is a time interval between time at which the reader/writer completes sending of one piece of signaling and time at which the reader/writer starts to send a next piece of signaling (there is no feedback from the tag during T4, that is, there is no uplink signaling during T4). T3 is an extra delay that the reader/writer is to wait for in response to there being no tag feedback in response to the reader/writer executing the inventory process. T2 is a time interval between time at which the tag completes sending of signaling and time at which the reader/writer starts to send signaling.

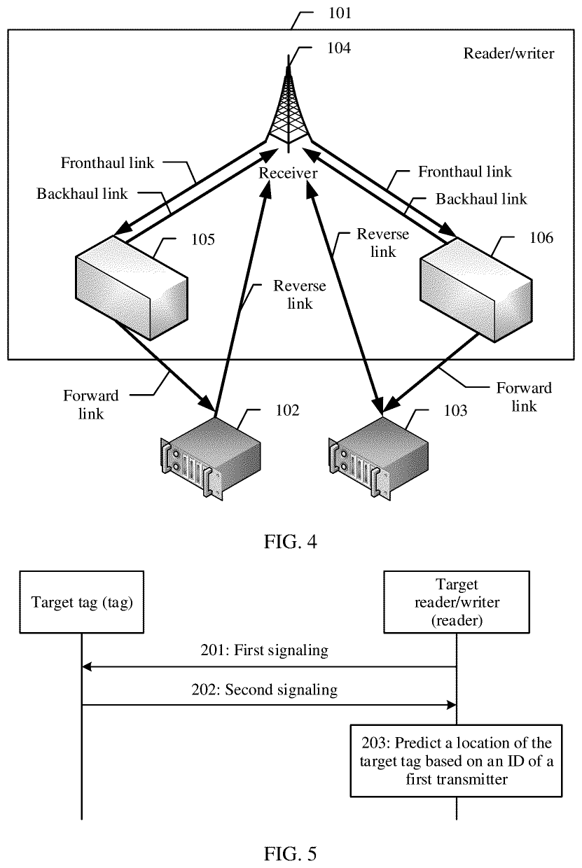

FIG. 4 is a schematic diagram of an embodiment of a tag positioning system according to at least one embodiment.

Refer to FIG. 4. As shown in FIG. 4, the tag positioning system provided in this application includes a reader/writer 101, a tag 102, and a tag 103. In a separation architecture, the reader/writer 101 included in the tag positioning system provided in this application is separated into a receiver (receiver) 104, a transmitter (helper) 105, and a transmitter 106.

In at least one embodiment, a link between an air interface of a target reader/writer and an air interface of a target tag is referred to as a forward link, and a link from the tag to the reader/writer is referred to as a reverse link.

In at least one embodiment, the transmitter sends, on the forward link, an excitation signal to the tag, and the receiver receives, on the reverse link, a reflected signal sent by the tag. In addition, after generating RFID signaling, the receiver sends the RFID signaling to the transmitter through the forward downlink, and the transmitter forwards, on the forward link, the RFID signaling to the tag.

In at least one embodiment, optionally, signaling is transmitted on a forward link between the transmitter and the receiver by using a fifth generation new radio (5^{th}-Generation New Radio, 5G NR) technology, signaling is transmitted between the transmitter and the receiver by using a fifth generation sidelink (5G sidelink) technology, and signaling is transmitted between the transmitter and the receiver by using another technology. This is not specifically limited herein.

In at least one embodiment, according to an energy supply mode, tags is classified into a passive tag, an active tag, and a semi-active tag. The active tag (active tag) is referred to as an active electronic tag, or also referred to as an active tag, and uses an in-card battery to provide partial or full energy for a microchip, but does not provide energy for data transmission between the tag and the reader/writer. An advantage of the active tag is that a recognition distance is long (up to ten meters), but a disadvantage of the active tag is that a service life is limited (three to ten years) and a price is high. An active reader/writer monitors all active tags within 100 meters.

In at least one embodiment, a battery in the semi-passive tag (semi-passive tag) supplies power only to a tag circuit that consumes little power, where the tag circuit in the tag uses power supply to maintain data, and a chip in the tag uses auxiliary support of a voltage to operate. The tag is in a sleep state before entering a working state. In the sleep state, the tag is equivalent to the passive tag, and a battery inside the tag consumes little energy. Therefore, the battery lasts for several years, or even for 10 years. In response to the tag entering a reading area of the reader/writer, the tag is excited by a radio frequency signal sent by the reader/writer. In response to the tag entering the working state, energy of information exchange between the tag and the reader/writer is mainly supported by the radio frequency energy supplied by the reader/writer (reflection modulation mode). A function of an internal battery of the tag is to compensate for insufficient radio frequency field strength at a location of the tag, and energy of the internal battery of the tag is not converted into radio frequency energy.

The passive tag does not include a battery and does not have a built-in battery. In response to an electronic tag being outside a reading range of the reader/writer, the electronic tag is in a passive state. In response to the electronic tag being within the reading range of the reader/writer, the electronic tag extracts, from radio frequency energy emitted by the reader/writer, a power supply used for the electronic tag to operate. A passive electronic tag generally transmits information to the reader/writer in a reflection modulation mode. A practical range of the passive tag is about 10 cm to a few meters. The passive tag has a light weight, a small volume, and a long service life. However, a transmit distance of the passive tag is limited, and the passive tag uses large transmit power of the reader/writer and low power consumption of a working circuit of a responder.

Optionally, the tag 102 and the tag 103 included in the tag positioning system provided in this application is active tags, the tag 102 and the tag 103 is passive tags, or the tag 102 and the tag 103 is semi-active tags. This is not specifically limited herein.

In at least one embodiment, an RFID system has other classification manners. Based on different modulation modes, tags is further classified into an active mode, a passive mode, and a semi-active mode. Based on whether stored information is written, tags are classified into a read-only tag and a read-write tag. Based on different packaging forms, tags is classed into a credit card tag, a linear tag, a paper tag, a glass tube tag, a round tag, and a special-purpose irregular-shaped tag. Tags in different classification manners are the same in the inventory process.

Based on the tag positioning system described in FIG. 4, a tag positioning method provided in at least one embodiment is described.

FIG. 5 is a schematic diagram of an embodiment of a tag positioning method according to at least one embodiment.

Refer to FIG. 5. The embodiment of the tag positioning method provided in at least one embodiment includes step 201 to step 203.

201: A target tag receives first signaling sent by a target reader/writer, and correspondingly, the target reader/writer sends the first signaling to the target tag.

In at least one embodiment, the target reader/writer includes a first transmitter and a first receiver, and the first signaling includes an identity ID of the first transmitter.

In at least one embodiment, the target reader/writer uses a transmit/receive separation architecture. After being separated, the target reader/writer includes at least the first transmitter and the first receiver. Optionally, the target reader/writer further includes more transmitters such as a second transmitter. This is not specifically limited herein. The target reader/writer sends the first signaling to the target tag. Optionally, the first signaling is inventory signaling, and the inventory signaling refers to signaling in an inventory process. Specifically, the inventory signaling is selection signaling Select, query signaling Query, acknowledgment signaling ACK, negative acknowledgment signaling NAK, and/or query signaling Queryrep. This is not specifically limited herein.

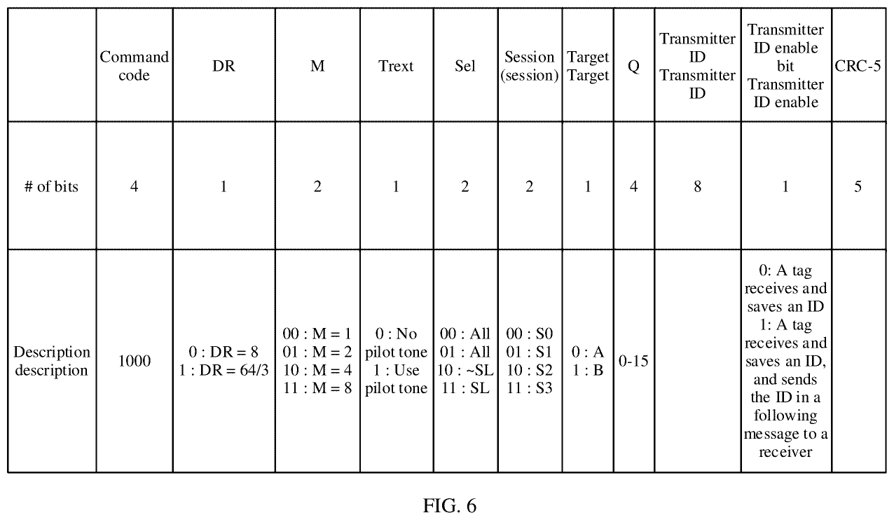

FIG. 6 is a schematic diagram of another embodiment of a tag positioning method according to at least one embodiment.

In at least one embodiment, an identity of a first transmitter is embodied in a form of an ID. For example, as shown in FIG. 6, the ID of the first transmitter is allocated by a central control unit (interrogator receiver). The ID of the first transmitter is carried in Query signaling. Query shown in FIG. 6 includes a first transmitter identity (transmitter ID) field, and the transmitter ID field indicates the ID of the first transmitter. Optionally, Query further includes an enable bit for indicating whether a tag is sent to a receiver. The target reader/writer determines, by configuring content in the enable bit, whether the target tag sends the ID of the first transmitter to the target reader/writer in a following piece of signaling.

Manner 1: A portion of the inventory signaling sent by the target reader/writer to the target tag carries the identity of the first transmitter.

In at least one embodiment, in response to the target reader/writer inventorying the target tag, the reader/writer first sends Select and Query to the tag to perform an inventory process. Optionally, the identity of the first transmitter is carried in Select and/or Query, so that the tag learns of the ID of the first transmitter in response to the inventory process starting, and adds the ID of the first transmitter to an RN 16 returned to the target reader/writer. Optionally, the identity of the first transmitter is also carried in ACK, NAK, Queryrep, and/or Queryadjust. This is not specifically limited herein.

Manner 2: All inventory signaling sent by the target reader/writer to the target tag carries the identity of the first transmitter.

In at least one embodiment, optionally, Select, Query, ACK, NAK, Queryrep, and/or Queryadjust that are sent by the target reader/writer to the target tag all carry the identity of the first transmitter.

In at least one embodiment, in response to the first transmitter selected by the target reader/writer changing, the identity of the first transmitter also changes accordingly. The target tag reports a changed identity of the first transmitter to the target reader/writer through second signaling, so that the target reader/writer learns that a location of the target tag changes, and locks the location of the target tag more accurately. Optionally, the tag is located in coverage areas of a plurality of transmitters. After the target reader/writer switches a transmitter, the identity of the first transmitter also changes accordingly. The target tag narrows down an area in which the target tag is located by using the coverage areas of the plurality of transmitters, to more accurately locate the target tag.

202: The target tag sends the second signaling to the target reader/writer, and correspondingly, the target reader/writer receives the second signaling sent by the target tag.

In at least one embodiment, the second signaling includes the ID of the first transmitter.

Optionally, the second signaling is reply signaling Reply in the inventory process, the second signaling is electronic product code EPC in the inventory process, or the second signaling is other signaling. This is not specifically limited herein.

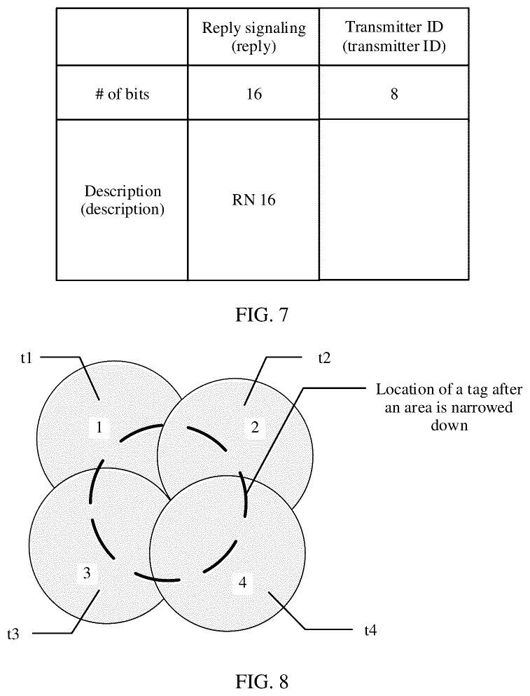

FIG. 7 is a schematic diagram of an embodiment of a tag positioning method according to at least one embodiment.

Refer to FIG. 7. For example, a first transmitter identity (transmitter ID) field included in Reply that is replied by a tag to a target reader/writer includes an identity of the transmitter. An implementation in which Reply includes the identity of the transmitter is shown in FIG. 7.

203: The target reader/writer predicts a location of the target tag based on the ID of the first transmitter.

In at least one embodiment, in different cases, the target reader/writer predicts the location of the target tag in different manners based on the ID that is of the first transmitter and that is reported by the target tag. The following example provides detailed description.

FIG. 8 is a schematic diagram of another embodiment of a tag positioning method according to at least one embodiment.

(1) A Tag is in a Static State.

As shown in FIG. 8, in response to the tag being in the static state, in different inventory cycles, a same tag sends inventory signaling through different transmitters in a process in which a reader/writer inventories the tag. The tag sends the inventory signaling through a transmitter whose ID is 1 at a moment t1, sends the inventory signaling through a transmitter whose ID is 2 at a moment t2, sends the inventory signaling through a transmitter whose ID is 3 at a moment t3, and sends the inventory signaling through a transmitter whose ID is 4 at a moment t4.

A receiver predicts a location of the tag by using the ID of the transmitter and a received signal strength indication (received signal strength indication, RSSI) for receiving the inventory signaling sent by the tag at different moments. In passive tag communication, the receiver also estimates the RSSI of the inventory signaling from the inventory signaling returned by the tag. In a process of signaling transmission between the tag and the reader/writer, parameters such as a reverse link transmission loss and a tag energy loss basically remain unchanged. Therefore, RSSIs received by the receiver at different moments is calculated by using the following formula:

RSSI of the receiver=transmitter power (Txpower)−forward link transmission loss−tag energy loss−reverse link transmission loss.

From the foregoing formula, an energy loss difference between forward link transmission losses in response to different transmitters being used to transmit the inventory signaling is applied to a positioning technology, and a range of a location of the tag is further determined by using the forward link transmission losses.

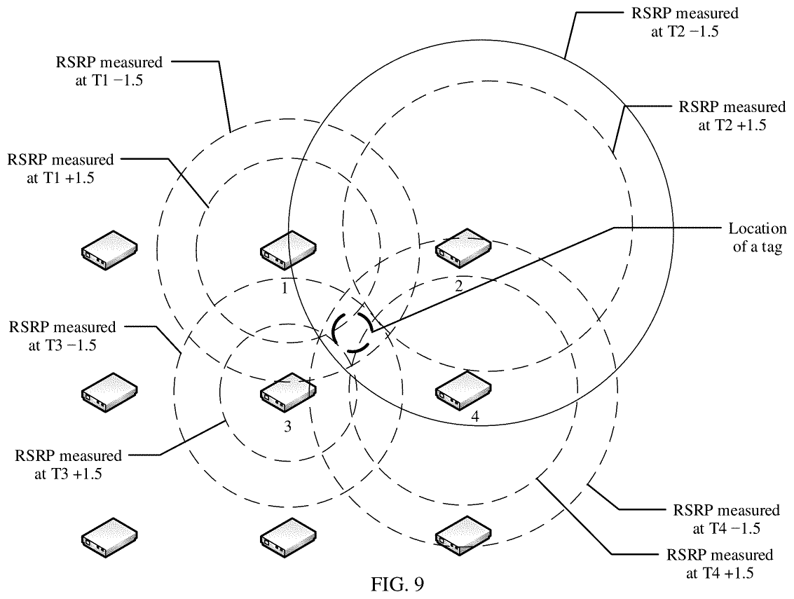

FIG. 9 is a schematic diagram of an embodiment of a tag positioning method according to at least one embodiment.

For example, a coverage area of a transmitter is divided by using reference signal received power (reference signal received power, RSRP) of the transmitter.

As shown in FIG. 9, for example, transmitters 1, 2, 3, and 4 are evenly distributed, and each RSRP measurement has a deviation, where the deviation is ±1.5 dB. A final location of a tag is determined to be in an area enclosed by four focal points in the figure. The location of the tag is concentrated in an area about 434 square meters, and average positioning precision is about 20 m. In response to a reader/writer not learning of an identity of a transmitter, only the transmitters 1, 2, 3, and 4 are available in an area, coverage areas of the four transmitters are about 180×180 square meters, and the positioning precision is about 180 m. The positioning precision is improved by 80%.

(2) The Tag is a Moving State.

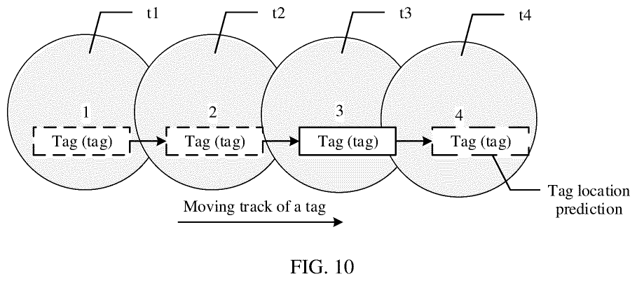

FIG. 10 is a schematic diagram of another embodiment of a tag positioning method according to at least one embodiment.

As shown in FIG. 10, in response to the tag being in the moving state, t1, t2, t3, and t4 represent different inventory moments. 1, 2, 3, and 4 indicate transmitters with different IDs. A reader/writer predicts, by using an ID that is of a transmitter and that is in inventory signaling sent by the tag, that a moving track of the tag is 1-2-3. In response to the tag sends the inventory signaling through a transmitter whose ID is 3 at the moment t3, the reader/writer predicts that the tag is about to send, at t4, the inventory signaling through a transmitter whose ID is 4. To be specific, the reader/writer predicts that a location of the tag is about to be covered by the transmitter whose ID is 4 at t4.

In at least one embodiment, in the tag positioning method, in addition to performing step 201 to step 203, the target tag further receives third signaling sent by the target reader/writer, where the third signaling indicates the target tag to send the second signaling. This specific implementation is described in the following method example.

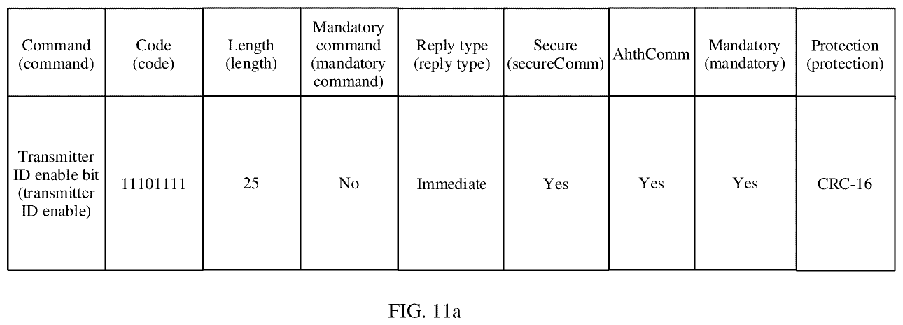

FIG. 11a is a schematic diagram of an embodiment of a tag positioning method according to at least one embodiment.

In at least one embodiment, a tag does not carry an identity of a transmitter in inventory signaling. After an inventory process ends, a target reader/writer sends an instruction to a target tag through third signaling, where the third signaling is dedicated signaling that indicates the target tag to send an identity of a first transmitter to the target reader/writer.

FIG. 11b is a schematic diagram of an embodiment of a tag positioning method according to at least one embodiment.

For example, in response to a transmitter ID enable bit carried by a reader/writer in inventory signaling being disabled, the inventory signaling sent by a tag to the reader/writer does not include an identity of a transmitter. Therefore, the reader/writer enables, through dedicated signaling after inventory, the tag to send, to the reader/writer, an identity of a transmitter of the reader/writer. The dedicated signaling is shown in FIG. 11a. In response to the tag receiving the dedicated signaling, the tag replies with response signaling for the dedicated signaling. The response signaling also includes an identity of a first transmitter. The response signaling is shown in FIG. 11b.

In at least one embodiment, the target tag receives the first signaling sent by the target reader/writer, where the first signaling includes the identity ID of the first transmitter. The target tag sends the second signaling to the target reader/writer, where the second signaling includes the ID of the first transmitter. Further, the target reader/writer determines, based on the ID that is of the first transmitter and that is included in the signaling sent by the target tag, a coverage area that is of a transmitter and in which the target tag is located, to more accurately determine a location of the tag. Therefore, efficiency of tag positioning is improved.

In the tag positioning method provided in at least one embodiment, in addition to step 201 to step 203 included in the embodiment shown in FIG. 5, the target tag further reports fourth signaling to the target reader/writer after determining that a reporting condition is met. This specific implementation is described in detail in the following example.

In response to the target tag determining that the reporting condition is met, the target tag sends the fourth signaling to the target reader/writer.

In at least one embodiment, optionally, the reporting condition of the tag is sent by the reader/writer, or the reporting condition of the tag is obtained in another manner. This is not specifically limited herein. Optionally, the reporting condition is that the tag switches a transmitter, the reporting condition is that preset reporting time of the tag is reached, or the reporting condition is another condition. This is not specifically limited herein.

(1) The Tag Switches a Transmitter.

In this embodiment, the target reader/writer includes the first transmitter and a second transmitter, and the first transmitter and the second transmitter are not a same network device. The target tag communicates with the target reader/writer through the first transmitter. After the target tag moves, and the target tag goes beyond a coverage area of the first transmitter and enters a coverage area of the second transmitter, the target tag switches a transmitter and communicates with the target reader/writer through the second transmitter. Alternatively, coverage areas of the first transmitter and the second transmitter overlap, and the target tag switches from the first transmitter to the second transmitter. In this case, an identity that is of a transmitter and that is included in signaling sent by the target reader/writer and that is received by the target tag again is the identity of the second transmitter, and the target tag confirms that the received identity of the transmitter is switched from the identity of the first transmitter to the identity of the second transmitter. That is, the received identity of the transmitter changes. In this case, the target tag determines that the reporting condition is met, and the target tag sends the identity of the second transmitter to the target reader/writer through the fourth signaling. Optionally, the fourth signaling is signaling included in the inventory signaling (such as Select, Query, Reply, ACK, NAK, EPC, Queryrep, and/or Queryadjust). Signaling included in the fourth signaling is also signaling other than the inventory signaling. This is not specifically limited herein.

(2) The Preset Reporting Time of the Tag Reaches.

In at least one embodiment, the first transmitter and the second transmitter are a same network device. After determining that the preset reporting time reaches, the target tag reports the identity of the second transmitter (the identity of the first transmitter) to a receiver of the reader/writer through the fourth signaling. Optionally, the preset reporting time is obtained by skilled persons by configuring for the target tag through the target tag, and the preset reporting time is sent by a receiver to the target tag through the inventory signaling or other signaling. The preset reporting time is also obtained in another manner. The reader/writer specifies, through the first signaling, the target tag to report the identity of the first transmitter in specific signaling. This is not specifically limited herein.

In at least one embodiment, optionally, the first signaling further includes reporting time of the identity of the first transmitter.

Optionally, the target reader/writer sends the reporting time of the identity of the first transmitter to the target tag through the first signaling. The reporting time specifies that the target tag sends the identity of the first transmitter to the target reader/writer at a specific moment, and the reporting time specifies that the target tag sends the identity of the first transmitter to the target reader/writer after a time period. For example, inventory signaling Select includes the reporting time, and the reporting time indicate the tag to carry an identity of a transmitter at a moment of sending EPC. The reader/writer sends Select that carries the reporting time to the tag, and after the tag receives Select, the tag carries the identity of the transmitter in response to sending the EPC. The reporting time is alternatively the target tag sends the identity of the first transmitter to the target reader/writer after receiving the third signaling mentioned in the foregoing embodiment. This is not specifically limited herein.

In at least one embodiment, optionally, the first signaling further includes a quantity of reporting times of the identity of the first transmitter.

In at least one embodiment, the target reader/writer sends, to the target tag through the first signaling, the quantity of reporting times of the identity of the first transmitter.

(1) Report for One Time or Report in all Signaling

For example, the quantity that is of reporting times and that is included in the first signaling indicates that the identity of the first transmitter is reported for one time. The reader/writer specifies, through the first signaling, the target tag to report the identity of the first transmitter in specific signaling. After the identity of the first transmitter is reported to the target reader/writer in the specific signaling, the identity of the first transmitter is no longer reported to the target reader/writer in other signaling than the specific signaling. The quantity that is of reporting times and that is included in the first signaling indicates to report the identity of the first transmitter in all signaling. The reader/writer specifies, through the first signaling, the target tag to report the identity of the first transmitter in all signaling that is sent to the reader/writer. The signaling mentioned in this embodiment is signaling included in the inventory signaling, or is signaling other than the inventory signaling. This is not specifically limited herein. In at least one embodiment, signaling that is received by the target tag earlier than the first signaling carries an identity of a transmitter used last time, or carries an invalid identity. This is not specifically limited herein.

(2) Random Reporting

For example, in this application, the quantity that is of reporting times and that is included in the first signaling indicates random reporting, the identity that is of the first transmitter and that is sent by the target tag to the reader/writer is included in any piece of signaling, and the target reader/writer identifies, in a plurality of manners, the signaling that carries the identity of the first transmitter.

Method 1: A Flag Bit Identifies the Signaling that Carries the Identity of the First Transmitter.

For example, the flag bit is added to the signaling sent by the target tag to the target reader/writer. A size of the flag bit is 1 bit, and 0 and 1 indicate whether the signaling carries the identity of the first transmitter. In response to the flag bit included in the signaling being 1, the signaling carries the identity of the first transmitter. On the contrary, in response to the flag bit included in the signaling being 0, the signaling does not carry the identity of the first transmitter. Optionally, in response to the flag bit being 0, the signaling carries the identity of the first transmitter, and in response to the flag bit being 1, the signaling does not carry the identity of the first transmitter. This is not specifically limited herein. In at least one embodiment, a size of the flag bit is 1 bit, is 2 bits, or is other sizes. This is not specifically limited herein.

Method 2: A Preamble Identifies the Signaling that Carries the Identity of the First Transmitter.

For example, in response to the signaling including the identity of the first transmitter, a first-type preamble is used. In response to the signaling not including the identity of the first transmitter, a second-type preamble is used. In this manner, a receiver is to have a function of blindly detecting two types of preambles at the same time, and functions corresponding to different preambles is preconfigured. A central processing unit sends a function corresponding to the guide header to the receiver and a transmitter, and the transmitter sends the function of the preamble to the tag through signaling in a broadcast mode. The signaling includes a specific flag bit, and the specific flag bit indicates that the signaling is common signaling or dedicated signaling.

In at least one embodiment, optionally, the identity of the first transmitter is sent to the target reader/writer in a plaintext transmission manner. Optionally, the identity of the first transmitter is transmitted to the target reader/writer in an encrypted transmission manner. For example, the target tag encrypts the identity of the first transmitter and an RN 16 in an exclusive OR manner, and then send the encrypted identity to the target reader/writer. Alternatively, the target tag encrypts the identity of the first transmitter in another manner, and send the encrypted identity to the target reader/writer. This is not specifically limited.

Method 3: A Specific ID Identifies the Signaling that Carries the Identity of the First Transmitter.

In at least one embodiment, in response to signaling sent by the tag to the reader/writer not including an identity of a transmitter, the tag scrambles the signaling by using the specific ID, and the reader/writer obtains the specific ID after descrambling the signaling, where the specific ID indicates that the signaling does not include the identity of the transmitter.

In at least one embodiment, optionally, the specific ID is preset in the tag, or the specific ID is sent by a central control unit to a receiver and a transmitter. The transmitter sends the specific ID to the tag through signaling. The signaling includes a specific flag bit, and the specific flag bit indicates that the signaling sends a specific ID or an ID of a transmitter. This is not specifically limited herein.

In a process of encrypted transmission, the tag further sends the ID of the first transmitter to the reader/writer in an implicit transmission manner.

Optionally, in at least one embodiment, in response to the signaling sent by the tag to the reader/writer including an identity of a transmitter, the tag scrambles the signaling by using the identity of the transmitter, and the reader/writer obtains the identity that is of the transmitter and that is sent by the tag after descrambling the signaling.

For example, in response to the tag receiving Req-RN signaling sent by the transmitter, the tag scrambles an RN 16 by using the ID of the transmitter, and sends scrambled signaling to the reader/writer. The reader/writer determines, by using whether the signaling is descrambled, whether the identity of the transmitter matches, and obtain the ID of the transmitter after descrambling the signaling.

Optionally, in at least one embodiment, to improve security, the RN 16 between the reader/writer and the tag is updated at intervals. The reader/writer sends Req_RN under an RFID protocol to the tag, and the tag obtains a new RN 16 after receiving Req_RN. In at least one embodiment, optionally, a time-variant parameter is introduced. The tag generates an encryption result after performing exclusive OR processing on the time-variant parameter, the original RN 16, and an ID of a transmitter, and the tag sends the encryption result to the reader/writer. In response to the reader/writer learning the original RN 16 and the time-variant parameter, the reader/writer decrypts the encryption result again in an exclusive OR manner to obtain the ID of the transmitter.

In at least one embodiment, there are a plurality of manners of generating the time-variant parameter. Optionally, the time-variant parameter is generated by the tag, and after generating the time-variant parameter, the tag sends the time-variant parameter to the reader/writer through signaling. Optionally, the time-variant parameter is generated by a transmitter. After generating the time-variant parameter, the transmitter separately sends the time-variant parameter to the tag and a receiver. Optionally, the time-variant parameter is generated in another manner. This is not specifically limited herein.

For example, an identity of a transmitter has 16 bits. A={A0, A1, . . . , A16}, and A represents the identity of the transmitter. B={B0, B1, . . . , B16}, and B represent the original RN 16. T={T0, T1, . . . , T16}, and T represents the time-variant parameter. After the tag performs exclusive OR processing on A, B, and T, the tag sends an obtained result C to the reader/writer through signaling. After the reader/writer receives the signaling, since B and T are known to the reader/writer, the reader/writer performs exclusive OR processing on C, B, and T to obtain A.

In at least one embodiment, optionally, the target reader/writer obtains first configuration information through the first receiver.

The first configuration information indicates a location of a third transmitter and/or a deployment relationship between a plurality of third transmitters, and the first configuration information further includes an ID of the third transmitter. The third transmitter refers to a transmitter in a subset of all transmitters communicating with the first receiver, and the third transmitter includes the first transmitter. Optionally, the first receiver obtains the first configuration information through a network device such as a database or a server that stores a topological relationship. Alternatively, the first receiver receives the first configuration information sent by one or more third transmitters. Alternatively, the first receiver obtains the first configuration information in another manner. This is not specifically limited herein.

In at least one embodiment, optionally, the target reader/writer further sends second configuration information to the transmitter through the receiver.

The second configuration information indicates a configuration required for communication between the target tag and the target reader/writer. The tag communicates with the reader/writer through a transmitter A. In response to the tag moving, after the reader/writer predicts a moving track of the tag, the reader/writer infers that the tag communicates with the reader/writer through a transmitter B at a next moment. The reader/writer sends the second configuration information to the transmitter B. For example, the reader/writer adds a mask (mask) (the second configuration information) to the selection signaling Select sent to the transmitter B, to accelerate an Inventory speed of the tag by the reader/writer and improve inventory efficiency. Optionally, the second configuration information further includes other content. This is not specifically limited herein.

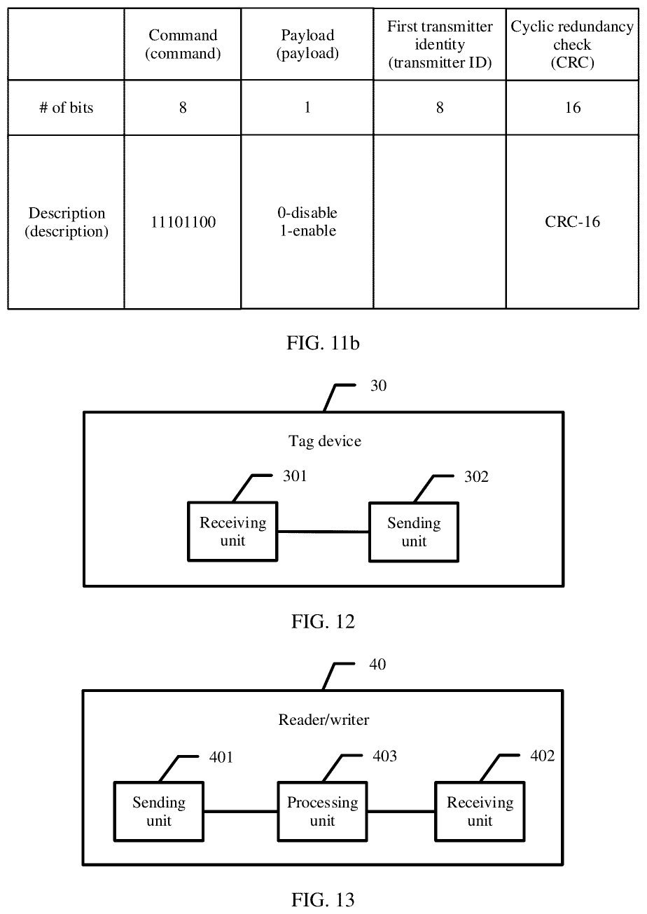

The foregoing examples provide different implementations of a tag inventory method. The following provides a tag device 30. As shown in FIG. 12, the tag device 30 is configured to perform steps performed by the target tag in the foregoing examples. For specific understanding of execution steps and corresponding beneficial effects, refer to the foregoing corresponding examples. Details are not described herein again. The tag device 30 includes: a receiving unit 301, configured to receive first signaling sent by a target reader/writer, where the target reader/writer includes a first transmitter and a first receiver, and the first signaling includes an identity of the first transmitter; and a sending unit 302, configured to send second signaling to the target reader/writer, where the second signaling includes the identity of the first transmitter.

In at least one embodiment, the first signaling includes inventory signaling, and the inventory signaling includes selection signaling Select, query signaling Query, acknowledgment signaling ACK, negative acknowledgment signaling NAK, and/or query signaling Queryrep.

In at least one embodiment, the second signaling includes the inventory signaling, and the inventory signaling includes reply signaling Reply and/or electronic product code EPC.

In at least one embodiment, the receiving unit 301 is further configured to receive third signaling sent by the target reader/writer, where the third signaling indicates the target tag to send the second signaling to the target reader/writer.

In at least one embodiment, the processing unit is further configured to determine whether a reporting condition is met.

The sending unit 302 is further configured to send fourth signaling to the target reader/writer, where the fourth signaling includes an identity of a second transmitter.

In at least one embodiment, the first signaling includes reporting time of the identity of the first transmitter.

In at least one embodiment, the first signaling includes a quantity of reporting times of the identity of the first transmitter.

In at least one embodiment, the identity of the first transmitter is transmitted in plaintext, or the identity of the first transmitter is transmitted in encrypted transmission.

Content such as information interaction between the modules of the tag device 30 and execution processes thereof is based on a same idea as the method examples in at least one embodiment, and execution steps of the tag device 30 are consistent with detailed content of the foregoing method steps. For details, refer to descriptions in the foregoing method examples.

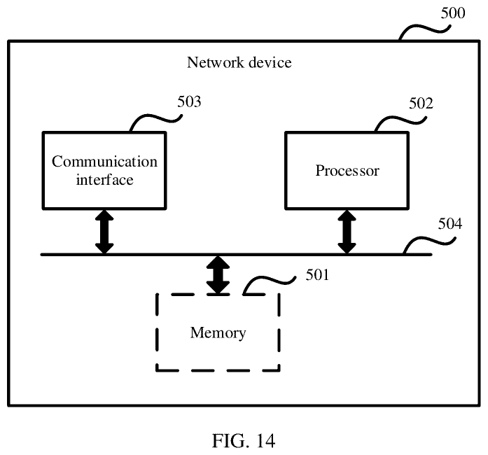

The foregoing examples provide different implementations of the tag device 30. The following provides a reader/writer 40. As shown in FIG. 13, the reader/writer 40 is configured to perform steps performed by the target reader/writer in the foregoing examples. For specific understanding of execution steps and corresponding beneficial effects, refer to the foregoing corresponding examples. Details are not described herein again. The reader/writer 40 includes: a sending unit 401, configured to send first signaling to a target tag, where the target reader/writer includes a first transmitter and a first receiver, and the first signaling includes an identity of the first transmitter; a receiving unit 402, configured to receive second signaling sent by the target tag, where the second signaling includes the identity of the first transmitter; and a processing unit 403, configured to predict a location of the target tag based on the identity of the first transmitter.

In at least one embodiment, the first signaling includes inventory signaling, and the inventory signaling includes selection signaling Select, query signaling Query, acknowledgment signaling ACK, negative acknowledgment signaling NAK, and/or query signaling Queryrep.

In at least one embodiment, the second signaling includes the inventory signaling, and the inventory signaling includes reply signaling Reply and/or electronic product code EPC.

In at least one embodiment, the sending unit 401 is further configured to send third signaling to the target tag, where the third signaling indicates the target tag to send the second signaling to the target reader/writer.

In at least one embodiment, the reader/writer includes a third transmitter; and the receiving unit 402 is further configured to obtain first configuration information through the first receiver, where the first configuration information indicates a location of the third transmitter and/or a deployment relationship between a plurality of third transmitters.

In at least one embodiment, the sending unit 401 further sends second configuration information to the transmitter through the receiver, where the second configuration information indicates a configuration used for communication between the target tag and the target reader/writer.

Content such as information interaction between the modules of the reader/writer 40 and execution processes thereof is based on a same idea as the method examples in at least one embodiment, and execution steps of the reader/writer 40 are consistent with detailed content of the foregoing method steps. For details, refer to descriptions in the foregoing method examples.

FIG. 14 is a schematic diagram of a structure of a network device 500 according to at least one embodiment. The network device is a tag device, or the network device is a reader/writer. This is not specifically limited herein. The network device 500 includes a processor 502, a communication interface 503, and a memory 501. Optionally, the network device 500 includes a bus 504. The communication interface 503, the processor 502, and the memory 501 is connected to each other through the bus 504. The bus 504 is a peripheral component interconnect (Peripheral Component Interconnect, PCI) bus, an extended industry standard architecture (extended industry standard architecture, EISA) bus, or the like. The bus is classified into an address bus, a data bus, a control bus, and the like. For ease of representation, only one bold line represents the bus in FIG. 14, but this does not mean that there is only one bus or only one type of bus. The network device 500 implements a function of the tag device in FIG. 12, or the network device 500 implements a function of the reader/writer in the example shown in FIG. 13. The processor 502 and the communication interface 503 performs corresponding operations of the tag device or the reader/writer in the foregoing method examples.

The following specifically describes the components of the network device with reference to FIG. 14.

The memory 501 is a volatile memory (volatile memory) such as a random access memory (random-access memory, RAM); or a non-volatile memory (non-volatile memory), for example, a read-only memory (read-only memory, ROM), a flash memory (flash memory), a hard disk drive (hard disk drive, HDD), or a solid-state drive (solid-state drive, SSD); or a combination of the foregoing types of memories, configured to store program code, a configuration file, or other content for implementing the method in at least one embodiment.

The processor 502 is a control center of a controller, and is a central processing unit (central processing unit, CPU), or is an application-specific integrated circuit (application specific integrated circuit, ASIC), or one or more integrated circuits configured to implement the examples provided in at least one embodiment, for example, one or more digital signal processors (digital signal processor, DSP), or one or more field programmable gate arrays (field programmable gate array, FPGA).

The communication interface 503 is configured to communicate with another network device.

The processor 502 performs an operation performed by the tag device in the example shown in FIG. 12, or an operation performed by the reader/writer in the example shown in FIG. 13. Details are not described herein again.

Content such as information interaction between the modules of the network device 500 and execution processes thereof is based on a same idea as the method example in this application, and execution steps of the network device 500 are consistent with detailed content of the foregoing method steps. For details, refer to descriptions in the foregoing method example.

A person skilled in the art understands that, for the purpose of convenient and brief description, for a detailed working process of the foregoing system, apparatus, and unit, refer to a corresponding process in the foregoing examples. Details are not described herein again.

In the several examples provided in at least one embodiment, the disclosed system, apparatus, and method is implemented in other manners. For example, the described apparatus example is merely an example. For example, the unit division is merely logical function division and is other division in actual implementation. For example, a plurality of units or components is combined or integrated into another system, or some features is ignored or not performed. In addition, the displayed or discussed mutual couplings or direct couplings or communication connections is implemented by using some interfaces. The indirect couplings or communication connections between the apparatuses or units is implemented in electrical, mechanical, or other forms.

The units described as separate parts may or may not be physically separate, and parts displayed as units may or may not be physical units, is located in one location, or is distributed on a plurality of network units. Some or all of the units is selected to achieve the objective of this example.

In addition, functional units in the examples of at least one embodiment is integrated into one processing unit, each of the units exist alone physically, or two or more units are integrated into one unit. The integrated unit is implemented in a form of hardware, or is implemented in a form of a software functional unit.

In response to the integrated unit being implemented in the form of the software functional unit and sold or used as an independent product, the integrated unit is stored in a computer-readable storage medium. Based on such an understanding, the technical solutions of at least one embodiment essentially, or a part that contributes to the conventional technology, or all or a part of the technical solutions is implemented in a form of a software product. The computer software product is stored in a storage medium and includes several instructions for instructing a computer device (which is a personal computer, a server, a network device, or the like) to perform all or some steps of the methods in the examples of at least one embodiment. The foregoing storage medium includes any medium that stores program code, such as a USB flash drive, a removable hard disk, a read-only memory (ROM, read-only memory), a random access memory (RAM, random access memory), a magnetic disk, or an optical disc.

In the foregoing specific implementations, the objectives, technical solutions, and benefits of the present invention are further described in detail. Different embodiments are combined, and the foregoing descriptions are merely specific implementations of the present invention, but are not intended to limit the protection scope of the present invention. Any combination, modification, equivalent replacement, improvement, or the like made without departing from the spirit and principle of the present invention shall fall within the protection scope of the present invention. In conclusion, the foregoing examples are merely intended for describing the technical solutions of at least one embodiment, but not for limiting embodiments described herein. Although embodiments are described in detail with reference to the foregoing examples, persons of ordinary skill in the art should understand that they are still able to make modifications to the technical solutions described in the foregoing examples or make equivalent replacements to some technical features thereof, without departing from the scope of the technical solutions of examples of embodiments described herein.

1. A tag positioning method, comprising:
receiving, by a target tag, first signaling from a target reader/writer, wherein the target reader/writer includes a first transmitter and a first receiver, and the first signaling includes an identity of the first transmitter; and
sending, by the target tag, second signaling to the target reader/writer, wherein the second signaling includes the identity of the first transmitter.

2. The tag positioning method according to claim 1, wherein the receiving the first signaling includes receiving inventory signaling, and the inventory signaling includes selection signaling Select, query signaling Query, acknowledgment signaling ACK, negative acknowledgment signaling NAK, and/or query signaling Queryrep.

3. The tag positioning method according to claim 2, wherein the sending the second signaling includes sending the inventory signaling, and the inventory signaling includes reply signaling Reply and/or electronic product code EPC.

4. The tag positioning method according to claim 1, wherein the receiving the first signaling includes receiving reporting time of the identity of the first transmitter.

5. The tag positioning method according to claim 1, wherein the receiving the first signaling includes receiving a quantity of reporting times of the identity of the first transmitter.

6. A tag positioning method, comprising:
sending, by a target reader/writer, first signaling to a target tag, wherein the target reader/writer includes a first transmitter and a first receiver, and the first signaling includes an identity of the first transmitter;
receiving, by the target reader/writer, second signaling from the target tag, wherein the second signaling includes the identity of the first transmitter; and
predicting, by the target reader/writer, a location of the target tag based on the identity of the first transmitter.

7. The tag positioning method according to claim 6, wherein the sending the first signaling includes sending inventory signaling, and the inventory signaling includes selection signaling Select, query signaling Query, acknowledgment signaling ACK, negative acknowledgment signaling NAK, and/or query signaling Queryrep.

8. The tag positioning method according to claim 6, wherein the second signaling includes the inventory signaling, and the inventory signaling includes reply signaling Reply and/or electronic product code EPC.

9. The tag positioning method according to claim 6, wherein the target reader/writer includes a third transmitter, and the method further comprises:
obtaining, by the target reader/writer, first configuration information through the first receiver, wherein the first configuration information indicates a location of the third transmitter and/or a deployment relationship between a plurality of third transmitters.

10. The tag positioning method according to claim 6, wherein the method further comprises:
sending, by the target reader/writer, second configuration information to the transmitter through the receiver, wherein the second configuration information indicates a configuration required for communication between the target tag and the target reader/writer.

11. An apparatus, comprising:
a communication interface;
a memory storing computer-readable instructions; and
a processor connected to the memory and the communication interface wherein the processor is configured to execute the computer-readable instructions to perform operations of:
receiving first signaling sent by a target reader/writer, wherein the target reader/writer includes a first transmitter and a first receiver, and the first signaling includes an identity of the first transmitter; and
sending second signaling to the target reader/writer, wherein the second signaling includes the identity of the first transmitter.

12. The apparatus according to claim 11, wherein the first signaling includes inventory signaling, and the inventory signaling includes selection signaling Select, query signaling Query, acknowledgment signaling ACK, negative acknowledgment signaling NAK, and/or query signaling Queryrep.

13. The apparatus according to claim 11, wherein the second signaling includes the inventory signaling, and the inventory signaling includes reply signaling Reply and/or electronic product code EPC.

14. The tag positioning method according to claim 11, wherein the first signaling includes reporting time of the identity of the first transmitter.

15. The apparatus according to claim 11, wherein the first signaling includes a quantity of reporting times of the identity of the first transmitter.

16. An apparatus, comprising:
a communication interface;
a memory storing computer-readable instructions; and
a processor connected to the memory and the communication interface wherein
the processor is configured to execute the computer-readable instructions to perform operations of:
sending first signaling to a target tag, wherein the target reader/writer includes a first transmitter and a first receiver, and the first signaling includes an identity of the first transmitter;
receiving second signaling sent by the target tag, wherein the second signaling includes the identity of the first transmitter; and
predicting a location of the target tag based on the identity of the first transmitter.

17. The apparatus according to claim 16, wherein the first signaling includes inventory signaling, and the inventory signaling includes selection signaling Select, query signaling Query, acknowledgment signaling ACK, negative acknowledgment signaling NAK, and/or query signaling Queryrep.

18. The apparatus according to claim 16, wherein the second signaling includes the inventory signaling, and the inventory signaling includes reply signaling Reply and/or electronic product code EPC.

19. The apparatus according to claim 16, wherein the target reader/writer includes a third transmitter, and the processor being further configured to perform an operation of:
obtaining first configuration information through the first receiver, wherein the first configuration information indicates a location of the third transmitter and/or a deployment relationship between a plurality of third transmitters.

20. The apparatus according to claim 16, wherein the processor is further configured to perform an operation of:
sending second configuration information to the transmitter through the receiver, wherein the second configuration information indicates a configuration required for communication between the target tag and the target reader/writer.
